(19) United States
(12) Patent Application Publication
(10) Pub. No.: US 2015/0198323 A1
(43) Pub. Date: Jul. 16, 2015

(54) LIGHT-EMITTING DEVICE

(71) Applicant: EPISTAR CORPORATION, Hsinchu (TW)

(72) Inventors: Chang-Ju HO, Hsinchu (TW); Chiu-Lin YAO, Hsinchu (TW)

(73) Assignee: EPISTAR CORPORATION, Hsinchu (TW)

(21) Appl. No.: 14/152,158

(22) Filed: Jan. 10, 2014

(51) Int. Cl. F21V 29/70; F21K 99/00

(52) U.S. Cl. CPC F21V 29/70; F21K 9/56; F21K 9/50

(57) ABSTRACT

Disclosed is a lighting-emitting device comprising a first light-emitting chip emitting a first light; a second light-emitting chip emitting a second light having a wavelength longer than that of the first light; and a heat sink nearer the second light-emitting chip than the first light-emitting chip, wherein the light-emitting device is operated from a cold state to a hot state, and a temperature of the second light-emitting chip is lower than that of the first light-emitting chip at the hot state.

### BACKGROUND

1. Technical Field

The present disclosure relates to a light-emitting device, and in particular to a light-emitting device comprising two chips emitting lights having different wavelength.

2. Description of the Related Art

The light-emitting diodes (LEDs) of the solid-state lighting elements have the characteristics of the low power consumption, low heat generation, long operational life, shockproof, small volume, quick response and good opto-electrical property like light emission with a stable wavelength so the LEDs have been widely used in household appliances, indicator light of instruments, and opto-electrical products, etc.

Though the LEDs have been widely used in light-emitting device in daily life, the light emitting efficiency of the light-emitting device has its drawbacks. The light emitting efficiency of a LED varies with the temperature, and to be more specific, the light emitting efficiency of a LED decreases while the temperature of a LED increases. Therefore, how to remove heat within a light-emitting device generated during operating is an important issue for a light-emitting device. Many efforts have been devoted to improve the ability of removing heat within a light-emitting device with a consideration of cost and efficiency of light extraction.

### SUMMARY OF THE DISCLOSURE

A light-emitting device comprising a first light-emitting chip emitting a first light; a second light-emitting chip emitting a second light having a wavelength longer than that of the first light; and a heat sink nearer the second light-emitting chip than the first light-emitting chip, wherein the light-emitting device is operated from a cold state to a hot state, and a temperature of the second light-emitting chip is lower than that of the first light-emitting chip at the hot state.

### BRIEF DESCRIPTION OF THE DRAWINGS

FIG. 1 shows a light-emitting device in accordance with an embodiment of the present disclosure.

FIG. 2 shows a top view of a light-emitting device in accordance with an embodiment of the present disclosure.

FIGS. 3a-3b show light-emitting devices in accordance with embodiments of the present disclosure.

FIG. 4 shows a light-emitting device in accordance with an embodiment of the present disclosure.

FIG. 5 shows a light-emitting device in accordance with an embodiment of the present disclosure.

FIG. 6 shows a light-emitting device in accordance with an embodiment of the present disclosure.

### DETAILED DESCRIPTION OF THE EMBODIMENTS

To better and concisely explain the disclosure, the same name or the same reference number given or appeared in different paragraphs or figures along the specification should has the same or equivalent meanings while it is once defined anywhere of the disclosure.

The following shows the description of the embodiments of the present disclosure in accordance with the drawings.

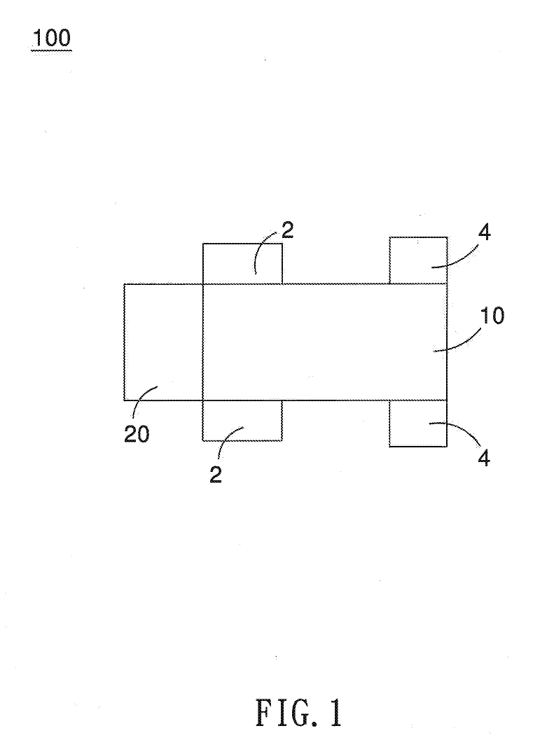

FIG. 1 shows a light-emitting device 100 in accordance with an embodiment of the present disclosure. The light-emitting device 100 comprises a substrate 10, a plurality of first light-emitting chips 2, a plurality of second light-emitting chips 4, and a heat dissipation element 20. A first combination of a first light-emitting chip 2 and a second light-emitting chip 4 is formed on a first surface of the substrate 10. A second combination of a first light-emitting chip 2 and a second light-emitting chip 4 is formed on the second surface of the substrate opposing to the first surface. The first light-emitting chip 2 emits a first light having a first wavelength and the second light-emitting chip 4 emits a second light having a second wavelength which is different from the first wavelength. To be more specific, the first wavelength is longer than the second wavelength. For example, the first light is a red light and the second light is a blue light. In this embodiment, the first combination and the second combination are configured to emit a white light. The characteristics of the white light emitted by the first combination can be different from or same with those of the light emitted by the second combination. The characteristics of the white light comprise color rendering index (CRI), color temperature, color over angle (COA), and light intensity. A heat dissipation element 20, which can be a heat sink, is connected to a third surface of the substrate 10 as shown in FIG. 1. Although the sizes of the two first light-emitting chips 2 are the same as shown in FIG. 1, but the sizes of the light-emitting chips (comprising the first light-emitting chip 2 and the second light-emitting chip 4) can be different in another embodiment.

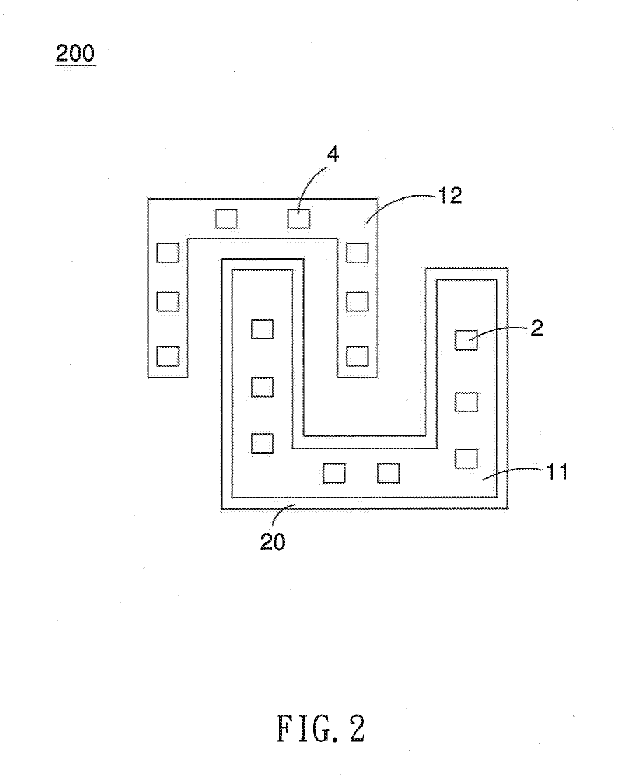

FIG. 2 shows a top view of a light-emitting device 200 in accordance with an embodiment of the present disclosure. The light-emitting device 200 comprises a first substrate 11, a second substrate 12, a plurality of first light-emitting chips 2, a plurality of second light-emitting chips 4, and a heat dissipation element 20. The plurality of the first light-emitting chips 2 are formed on a top surface of the first substrate 11 and the heat dissipation element 20 is formed on the bottom surface of the first substrate 11 opposite to the top surface. The plurality of the second light-emitting chips 4 are formed on a surface of the second substrate 12. In this embodiment, the first substrate 11 and the second substrate 12 are physically apart, and the plurality of the first light-emitting chips 2 are controlled by a control unit different from that controls the plurality of the second light-emitting chips 4. In another embodiment, the first light-emitting chips 2 and the second light-emitting chips 4 are electrically connected. In this embodiment, the first light-emitting chip 2 emits a red light and the second light-emitting chip 4 emits a blue light. The first light-emitting chip 2 and the second light-emitting chip 4 are insulated to each other. The heat dissipation element 20 is attached to the first substrate 11 which is nearer the plurality of the first light-emitting chips 2 than the plurality of the second light-emitting chips 4. In this embodiment, the area of the surface of the heat dissipation element 20 attached to is larger than the bottom surface of the first substrate 11. In another embodiment, the area of the surface of the heat dissipation element 20 attached to is equal to or smaller than the bottom surface of the first substrate 11. In another embodiment, the heat dissipation element 20 is connected to the side surface of the first substrate 11 and surrounds the first substrate 11 without contacting the bottom surface. Then, the top surface of the heat dissipation element 20 is at a same horizontal level with the top surface of the first substrate 11. In another embodiment, the top surface of the heat dissipation element 20 is at a horizontal level lower than the top surface of the first substrate 11. As the embodiment depicted in FIG. 1, the heat dissipation element is nearer the first light-emitting chip 2 than the second light-emitting chip 2.

As mentioned above, the first light-emitting chip 2 emits a red light and the second light-emitting chip 4 emits a blue light. Due to the materials of the first light-emitting chip 2 and the second light-emitting chip 4 are different, the hot/cold factor (H/C factor) of the first light-emitting chip 2 is different from that of the second light-emitting chip 4. Generally speaking, a light-emitting chip is operated with a lighting efficiency at the beginning, and the lighting efficiency is decreased after being operated for a while. That is, the light-emitting efficiency of a light-emitting chip is decreased from a cold state to a hot state after a period of operation. The description of the change of efficiency of a LED between a hot state and a cold state can be described as a formula below:

LED efficiency(hot state)=LED efficiency(cold state)−(H/C factor*T),

wherein the T in the formula depicts the difference of the temperature of a LED between the hot state and the cold state. Then, the efficiency of a LED at hot state is estimated by its efficiency at cold state, the H/C factor, and the amount of its temperature increase. The heat generated during light emission is not dissipated but is accumulated on the light-emitting chip and therefore reduces the light emitting efficiency of the light-emitting chip. It is noted that the H/C factor of a red light light-emitting chip is worse than a blue light light-emitting chip and the difference comes from the materials composing of the red light light-emitting chip and the blue light light-emitting chip. As for a light-emitting device emitting a white light comprising a red light-emitting chip and a blue light-emitting chip, after a period of operating, the light-emitting chips turn to hot state from cold state, and the white light emitted by the light-emitting device turns bluish because the lighting efficiency of the red light light-emitting chip decreases larger than that of the blue light light-emitting chip. A heat dissipation element is applied to reduce the effect arisen from the difference between the red light light-emitting chip and the blue light light-emitting chip. As the embodiments in FIGS. 1 and 2 show, the first light-emitting chips 2 have worse hot/cold factors than the second light-emitting chips 4. Meanwhile, the color temperature and the luminous of a light mixed by the first light and the second light changed and decreased after a period of operation. Thus, the heat dissipation element 20 is placed nearer the first light-emitting chip 2 than the second light-emitting chip 4 to suppress the effect arisen from the difference of H/C factors. Thus, the heat generated by the first light-emitting chip 2 is removed more easily than the heat generated by the second light-emitting chips 4. The temperature of the first light-emitting chips 2 is lower than the second light-emitting chips 4 after the light emitting device in FIGS. 1 and 2 are being operated for a period while the temperatures of the first light-emitting chips 2 and the second light-emitting chips 4 are the same at beginning. It also means the increase of a temperature of the first light-emitting chips 2 from the cold state to the hot state is less than that of the second light-emitting chips 4 from the cold state to the hot state. In the embodiments shown in FIGS. 1 and 2, the difference of temperature between a first light-emitting chip 2 and a second light-emitting chip 4 is between 10-80° C. after the light emitting device is operated for a period. Besides, the color temperature shifted from the cold state to the hot state is lower than 400K, and the color temperature of the light emitted by the light emitting device is between 2700-3500K at beginning and changes to 2300-3100K after being operated for a period. In another embodiment, the light-emitting device 100 is adapted to form a bulb, and the color temperature variation of the bulb between a hot state and a cold state is between 5%˜15%. In the embodiments shown in FIGS. 1 and 2, the heat conduction coefficient of the substrate is between 0.1-400 W/mk.

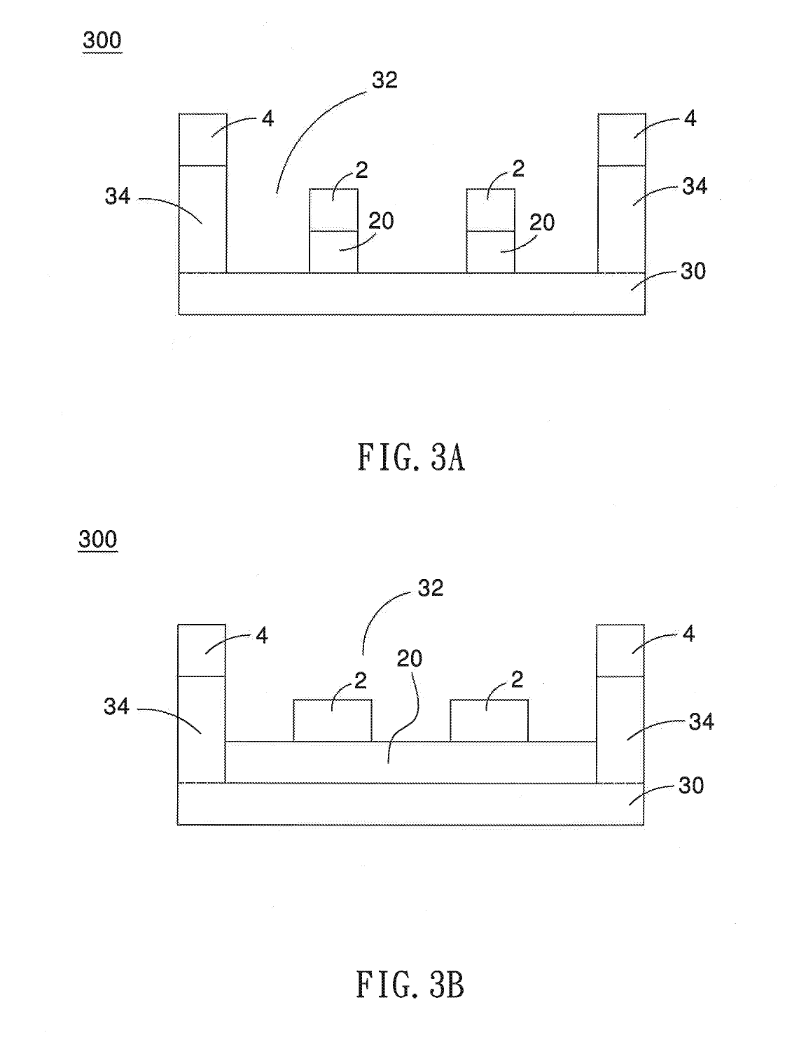

FIG. 3a shows a light-emitting device 300 in accordance with an embodiment of the present disclosure. The light-emitting device 300 comprises a substrate 30, a plurality of first light-emitting chips 2, a plurality of second light-emitting chips 4, and a plurality of heat dissipation elements 20. The substrate 30 comprises a depression 32, and two protrusions 34. The heat dissipation elements 20 are separately formed in the depression 32 of the substrate 30. The first light-emitting chips 2 are then respectively formed on the heat dissipation elements 20. The second light-emitting chips 4 are respectively formed on the protrusions 34 of the substrate 30. The plurality of the heat dissipation elements 20 are located between the plurality of the first light-emitting chips 2 and the substrate 30 but not between the plurality of the second light-emitting chips 4 and the substrate 30. The heat dissipation element 20 provides a path of heat dissipation in accordance with the first light-emitting chips 2. Thus the effect arisen from difference of the H/C factors between the first light-emitting chip 2 and the second light-emitting chip 4 are suppressed. Although the difference of H/C factors between two light-emitting chips remains the same, the difference of the temperature of the first light-emitting chip 2 between the cold state and the hot state is reduced. Thus, the difference of the light-emitting efficiency between hot state and cold state is also reduced. In this embodiment, the plurality of the heat dissipation elements 20 is apart from each other. Furthermore, the first light-emitting chips 2 can be arranged at a same horizontal level or at a different horizontal level compared with the second light-emitting chips 4 according to required light field distribution. Referring to FIG. 3b, the substrate 30 comprises a depression 32 and two protrusions 34. The heat dissipation element 20 is formed in the depression 32 and is connected to the two protrusions 34. The plurality of first light-emitting chips 2 is formed on the heat dissipation element 20. Besides, the surface of the heat dissipation element 20 connected to the first light-emitting chips 2 can be a flat surface or comprises a protruded part and/or a depressed part. In another embodiment, the heat dissipation element 20 is connected to the substrate 30 on a surface opposing to the first light-emitting chips 20 at the position under the first light-emitting chips 2. In another embodiment, a carrier is connected to a surface the substrate 30 opposing to the heat dissipation element 20 and the carrier can be a pedestal or a pillar to form a support like candlestick. In another embodiment, the protrusion 34 is formed between two first light-emitting chips 2. In another embodiment, the light-emitting device 300 comprises a second light-emitting chip 4 formed in the depression 32 without contacting the heat dissipation elements 20.

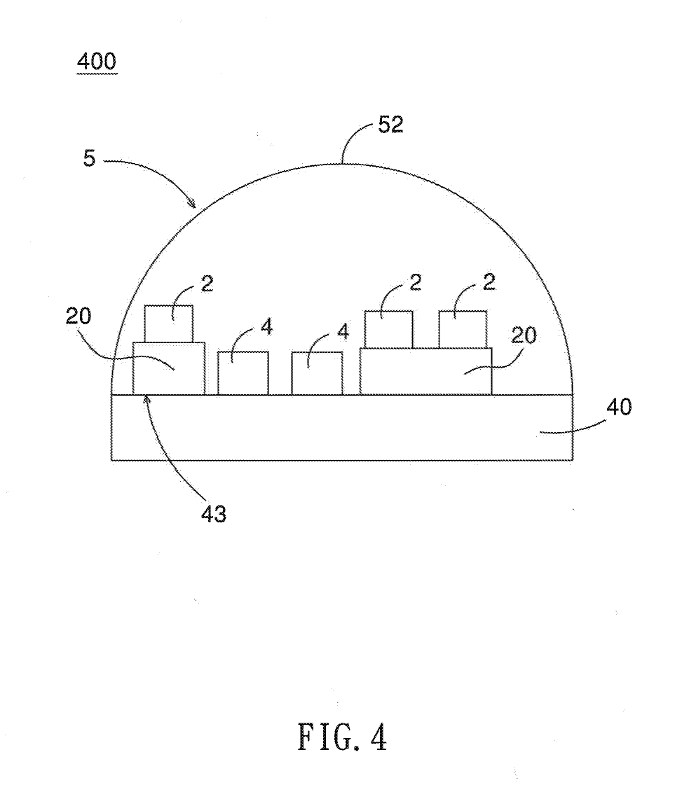

FIG. 4 shows a light-emitting device 400 in accordance with an embodiment of the present disclosure. The light-emitting device 400 comprises a substrate 40, a plurality of first light-emitting chips 2, a plurality of second light-emitting chips 4, a plurality of heat dissipation elements 20 and an optical element 5. The substrate 40 further comprises a surface 43 and the optical element 5 comprises a top 52 nearer the first light-emitting chip 2 than the second light-emitting chip 4. The optical element 5 covers the first light-emitting chip 2 and the second light-emitting chip 4. The optical element 5 can be a transparent cover which is transparent to the light emitted by the first light-emitting chip 2 and the second light-emitting chip 4. In another embodiment, the optical element 5 comprises a light scattering surface for improving light scattering. Furthermore, the substrate 40 comprises a portion protruded from the surface 43 for one or more light-emitting chips (the first light-emitting chip 2 and/or the second light-emitting chip 4) to be placed thereon to modify the distribution of light by arranging light-emitting chips on same or different horizontal levels. Besides, the optical element 5 can be in different shapes for different light distributions. In this embodiment, the first light-emitting chip 2 emits a red light, and the second light-emitting chip 4 emits a blue light. The optical element 5 comprises a wavelength converting material which converts a part of the blue light into a yellow light. The wavelength converting material can also be located in the space formed between the optical element 5 and the substrate 40, and the wavelength converting material can be optionally contacted with the light-emitting chips. Thus, the red light emitted by the first light-emitting chip 2, the yellow light excited by the blue light and the blue light emitted by the second light-emitting chip 4 are mixed to be a white light. In this embodiment, the light-emitting device 400 comprises a first light-emitting chip 2 on one heat dissipation element 20 and two first light-emitting chips 2 on another heat dissipation element 20. In another embodiment, the first light-emitting chips 2 are divided into groups of same or different amount and the groups are respectively formed on the heat dissipation elements 20, and each group of the first light-emitting chips 2 are arranged in a same arrangement or in different arrangements while formed on the heat dissipation elements 20. Besides, the optical element 5 comprises an opening for better heat dissipation. Although the sizes of the two first light-emitting chips 2 on one heat dissipation element 20 and the size of the first light-emitting chips 2 on the other heat dissipation element 20 are the same as shown in FIG. 4, but the sizes of the two first light-emitting chips 2 on one heat dissipation element 20 and/or the sizes of the first light-emitting chip 2 on different heat dissipation elements 20 can be different in another embodiment.

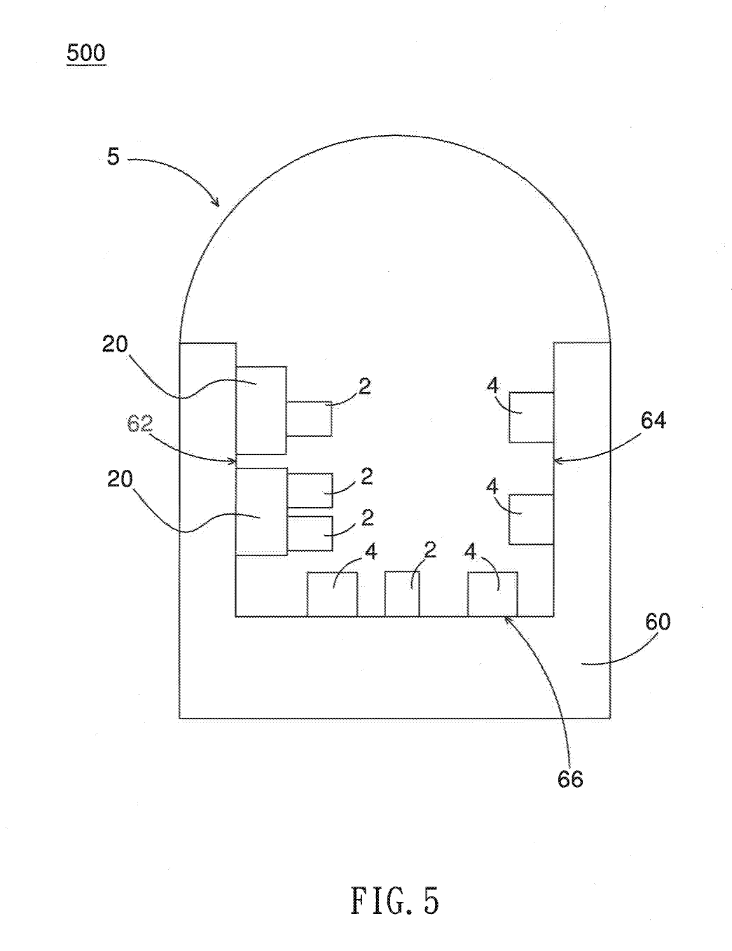

FIG. 5 shows a light-emitting device 500 in accordance with an embodiment of the present disclosure. The light-emitting device 500 comprises a substrate 60, a plurality of first light-emitting chips 2, a plurality of second light-emitting chips 4, a plurality of heat dissipation elements 20 and an optical element 5. The substrate 60 comprises a first section 62, a second section 64 and a third section 66. The plurality of the heat dissipation elements 20 is formed on the first section 62 and the plurality of the first light-emitting chips 2 is formed thereon. The plurality of second light-emitting chips 4 is formed on the second section 64. Thus, light-emitting surfaces of the plurality of first light-emitting chips 2 face the plurality of second light-emitting chips 4. The optical element 5 covers the first light-emitting chip 2 and the second light-emitting chip 4 and can be a cover which is transparent to the light emitted by the first light-emitting chip 2 and the second light-emitting chip 4. In this embodiment, the first light-emitting chip 2 emits a red light, and the second light-emitting chip 4 emits a blue light. After a period of operation, the temperature of the first section 62 is different from that of the second section 64, and the difference range is between 10-80° C. The light-emitting device 500 further comprises a reflective layer (not shown in the figure) optionally formed on any of the first section 62, the second section 64 and the third section 66 or commonly on the three sections. In another embodiment, light-emitting device 500 comprises a plurality of third light-emitting chips (not shown in the figure) emitting the first light and a plurality of fourth light-emitting chips (not shown in the figure) emitting the second light. The third light-emitting chips are optionally formed on a heat dissipation element 20. The third light-emitting chips are arranged in a first pattern and the fourth light-emitting chips are arranged in a second pattern different from or same as the first pattern. The third light-emitting chips and the fourth light-emitting chips can be formed on the first section, the second section and the third section respectively or simultaneously. In this embodiment, the distance between two first light-emitting chips 2 is equal to the distance between two second light-emitting chips 4. In another embodiment, a distance between two first light-emitting chips 2 is different from that between two second light-emitting chips 4. Accordingly, a distance between two third light-emitting chips is equal to or different from that between two fourth light-emitting chips.

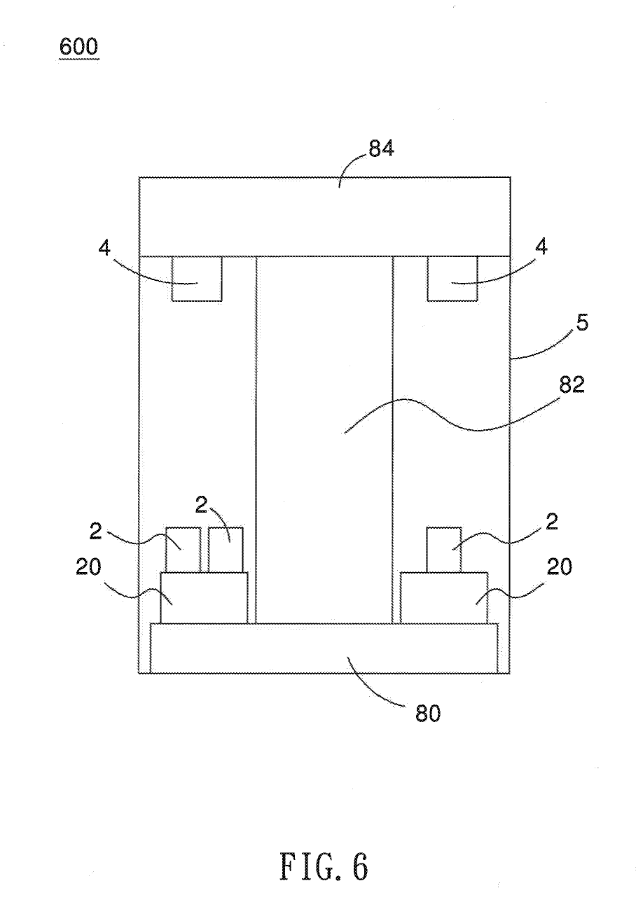

FIG. 6 shows a light-emitting device 600 in accordance with an embodiment of the present disclosure. The light-emitting device 600 comprises a stick 82, a first substrate 80, a second substrate 84, a plurality of first light-emitting chips 2, a plurality of second light-emitting chips 4, heat dissipation elements 20 and an optical element 5. The plurality of heat dissipation elements 20 are formed on the first substrate 80 and a plurality of first light-emitting chips are formed above. A plurality of second light-emitting chips 4 are formed on the second substrate 84. The first substrate 80 and the second substrate 84 are formed on opposing sides of the stick 82. Thus, a light-emitting surface of the first light-emitting chip 2 faces the second light-emitting chip 4. Furthermore, the stick 82 can provide a heat dissipation function and/or reflective function for improving heat dissipation and/or light extraction of the light-emitting device 600. The optical element 5 covers a plurality of first light-emitting chips 2 and a plurality of second light-emitting chips 4. The optical element 5 can be a transparent cover which is transparent to the light emitted by the first light-emitting chip 2 and the light emitted by the second light-emitting chip 4. In this embodiment, the first light-emitting chip 2 emits a red light, and the second light-emitting chip 4 emits a blue light. In another embodiment, the optical element 5 comprises a light scattering surface. The optical element 5 comprises a wavelength converting material which converts a part of the blue light into a yellow light wherein the wavelength converting material can be placed on outer surface and/or inner surface of the optical element 5. The red light, the yellow light and the blue light are mixed to be a white light. In another embodiment, the optical element 5 comprises an opening locating at a position close to the first light-emitting chip 2. In another embodiment, same or different numbers of light-emitting chips 2 are respectively formed on two heat dissipation elements 20 in a same arrangement or in different arrangements according to required light field distribution. As shown in FIG. 6, the light-emitting device 400 comprises a first light-emitting chip 2 on one heat dissipation element and two first light-emitting chips 2 on the other heat dissipation element. As mentioned above, the sizes of the light-emitting chips can be the same or different from each other in another embodiment.

It will be apparent to those having ordinary skill in the art that various modifications and variations can be made to the devices in accordance with the present disclosure without departing from the scope or spirit of the disclosure. In view of the foregoing, it is intended that the present disclosure covers modifications and variations of this disclosure provided they fall within the scope of the following claims and their equivalents.

What is claimed is:

1. A light-emitting device, comprising:
a first light-emitting chip emitting a first light, having a first temperature at a hot state while the light-emitting device is operated from a cold state to the hot state;
a second light-emitting chip emitting a second light, having a wavelength longer than that of the first light, having a second temperature at the hot state while the light-emitting device is operated from the cold state to the hot state; and
a heat sink nearer the second light-emitting chip than the first light-emitting chip, wherein the second temperature is lower than the first temperature.

2. The light-emitting device according to claim 1, further comprising a light emitted by the light-emitting device having a correlated color temperature shift of less than 400K from the cold state to the hot state.

3. The light-emitting device according to claim 1, wherein a temperature difference between the first light-emitting chip and the second light-emitting chip at the hot state is in a range of 10-80° C.

4. The light-emitting device according to claim 1, further comprising an optical element covering the first light-emitting chip and the second light-emitting chip.

5. The light-emitting device according to claim 4, wherein the optical element further comprises a wavelength conversion material.

6. The light-emitting device according to claim 1, wherein the substrate comprises a heat conduction coefficient between 0.1-400 W/mk.

7. The light-emitting device according to claim 1, further comprising a light having a temperature between 2700-3500K.

8. The light-emitting device according to claim 1, further comprising an increase of a temperature of the second light-emitting chip from the cold state to the hot state is less than that of the first light-emitting chip from the cold state to the hot state.

9. The light-emitting device according to claim 1, further comprising a first substrate and a second substrate, and the first light-emitting chip is on the first substrate and the second light-emitting chip is on the second substrate which is physically apart from the first substrate.

10. The light-emitting device according to claim 9, wherein a temperature difference between the first light-emitting chip and the second light-emitting chip is in a range of 10-80° C.

11. The light-emitting device according to claim 1, further comprising a transparent cover covering the first light-emitting chip and the second light-emitting chip.

12. The light-emitting device according to claim 11, wherein the transparent cover comprises a top nearer the first light-emitting chip than the second light-emitting chip.

13. The light-emitting device according to claim 11, wherein the transparent cover comprises a light scattering surface.

14. The light-emitting device according to claim 11, wherein the transparent cover comprises a through hole nearer one of the first light-emitting chip and the second light-emitting chip.

15. The light-emitting device according to claim 1, wherein the first light-emitting chip comprises a surface faces that of the second light-emitting chip.

16. The light-emitting device according to claim 1, further comprising a carrier having a first section and a second section, wherein the first light-emitting chip is on the first section and the second light-emitting chip is on the second section.

17. The light-emitting device according to claim 16, wherein a temperature difference between the first section and the second section is in a range of 10-80° C.

18. The light-emitting device according to claim 1, further comprising a third light-emitting chip not on the heat sink emitting the first light.

19. The light-emitting device according to claim 18, further comprising a fourth light-emitting chip not on the heat sink emitting the second light, and the third light-emitting chip with the first light-emitting chip are arranged in an arrangement different from that arranged by the second light-emitting chip and the fourth light-emitting chip.

20. The light-emitting device according to claim 19, further comprising a plurality of third light-emitting chips and a plurality of fourth light-emitting chips and a distance between two of the third light-emitting chips is equal to or different from that between two of the fourth light-emitting chips.
